(19) United States
(12) Patent Application Publication
(10) Pub. No.: US 2024/0273220 A1
(43) Pub. Date: Aug. 15, 2024

(54) INFORMATION PROCESSING SYSTEM, INFORMATION PROCESSING METHOD AND COMPUTER READABLE MEDIUM

(71) Applicant: Mitsubishi Electric Corporation, Tokyo (JP)

(72) Inventor: Tsunato NAKAI, Tokyo (JP)

(73) Assignee: Mitsubishi Electric Corporation, Tokyo (JP)

(21) Appl. No.: 18/643,437

(22) Filed: Apr. 23, 2024

Related U.S. Application Data
(63) Continuation of application No. PCT/JP2021/047341, filed on Dec. 21, 2021.

(51) Int. Cl. G06F 21/60; G06F 21/44; H04L 9/00

(52) U.S. Cl. CPC G06F 21/602; G06F 21/44; H04L 9/008

(57) ABSTRACT

Each device of a server device (101) and a client device (102) includes a normal execution unit and a secure execution unit virtually separated. The normal execution unit in each device authenticates validity of activating the secure execution unit with each other. When the validity of activating the secure execution unit is authenticated, a secure communication path is established between the secure execution units in each device. The secure execution unit in the server device (101) decrypts and aggregates model information provided from the client device (102) via the secure communication path. The secure execution unit in the server device (101) encrypts the model information obtained by aggregation, and transmits the model information encrypted to the normal execution unit in the server device (101). The normal execution unit in the server device (101) stores the model information obtained by aggregation in an encrypted state, in a storage unit.

### CROSS-REFERENCE TO RELATED APPLICATION

This application is a Continuation of PCT International Application No. PCT/JP2021/047341, filed on Dec. 21, 2021, which is hereby expressly incorporated by reference into the present application.

### TECHNICAL FIELD

The present disclosure relates to an information processing system, an information processing method and an information processing program. Especially, it relates to an information processing system being a distributed machine learning system represented by Federated learning, the information processing method and the information processing program.

### BACKGROUND ART

In a conventional distributed machine learning system represented by federated learning, learning data has not been collected from clients to a server, but client models being models learned at clients have been collected in a server. In this manner, model learning in consideration of privacy information included in learning data of clients has been performed. However, leakage of privacy information included in the learning data of the clients from the client models has started to be reported.

In Non-Patent Literature 1, by processing client models in TEE using TEE being a secure execution environment on a server, model learning in consideration of privacy information is performed. TEE is an abbreviation for Trusted Execution

Environment.

### CITATION LIST

### Non-Patent Literature

Non-Patent Literature 1: L. Zhao et al., “SEAR: Secure and Efficient Aggregation for Byzantine-Robust Federated Learning,” IEEE Transactions on Dependable and Secure Computing, 2021

### SUMMARY OF INVENTION

### Technical Problem

A conventional distributed machine learning system represented by federated learning has three main security and privacy problems as follows.
(1) A problem of leakage of privacy information from a client model transmitted from a device or an edge.
(2) A problem of learning poisoning and obstruction by false information from a malicious device or edge.
(3) A problem of theft or replication of a global model.

However, there is no solution to solve all the three problems above in conventional techniques in consideration of security and privacy. For example, in Non-Patent Literature 1, a solution using the secure execution environment such as TEE is proposed for the above problems (1) and (2). However, a solution for the problem (3) is not disclosed. Further, in Non-Patent Literature 1, there is a problem that the load on the system is increased due to use of the secure execution environment.

The present disclosure is aimed at providing an information processing system to realize federated learning in consideration of security and privacy while suppressing the load on a system due to security measures.

### Solution to Problem

There is provided according to one aspect of the present disclosure an information processing system including a server device and a client device, to exchange model information used for learning between the server device and the client device, wherein
each device of the server device and the client device includes a normal execution unit being a normal execution environment and a secure execution unit being a secure execution environment, as execution environments virtually separated,
the normal execution unit in the each device of the server device and the client device authenticates validity of activating the secure execution unit in the each device with each other, and when the validity of activating the secure execution unit in the each device is authenticated, establishes a secure communication path to transmit and receive data encrypted between secure execution units in the each device,
the secure execution unit in the server device performs an aggregation process to decrypt and aggregate the model information provided from the client device via the secure communication path, encrypts the model information obtained by the aggregation process, and transmits the model information encrypted to the normal execution unit in the server device, and
the normal execution unit in the server device stores the model information obtained by the aggregation process in an encrypted state, in a storage unit.

### Advantageous Effects of Invention

In the information processing system according to the present disclosure, a secure execution unit of a server device decrypts and aggregates model information provided via a secure communication path from a client device. Then, the secure execution unit of the server device encrypts the model information obtained by aggregation, and transmits the model information encrypted to a normal execution unit of the server device. The normal execution unit of the server device stores the model information obtained by aggregation in an encrypted state in a storage unit. Therefore, by the information processing system according to the present disclosure, it is possible to provide the information processing system to realize federated learning in consideration of security and privacy while suppressing the load on the system due to security measures.

### BRIEF DESCRIPTION OF DRAWINGS

FIG. 1 is a diagram illustrating a configuration example of an information processing system according to a first embodiment;

FIG. 2 is a diagram illustrating an example of a hardware configuration of a server device according to the first embodiment;

FIG. 3 is a sequence diagram illustrating an operation of collecting a client model in the information processing system according to the first embodiment;

FIG. 4 is a sequence diagram illustrating an operation of distributing a global model in the information processing system according to the first embodiment;

FIG. 5 is a diagram illustrating an example of a hardware configuration of the information processing system according to a variation of the first embodiment;

FIG. 6 is a diagram illustrating a configuration example of an information processing system according to a second embodiment;

FIG. 7 is a sequence diagram illustrating an operation of collecting a client model in the information processing system according to the second embodiment;

FIG. 8 is a sequence diagram illustrating an operation of distributing a global model in the information processing system according to the second embodiment;

FIG. 9 is a diagram illustrating a configuration example of an information processing system according to a third embodiment;

FIG. 10 is a sequence diagram illustrating an operation of collecting a client model in the information processing system according to the third embodiment;

FIG. 11 is a sequence diagram illustrating an operation of distributing a global model in the information processing system according to the third embodiment; and

FIG. 12 is a diagram illustrating a configuration example of an information processing system according to a fourth embodiment.

### DESCRIPTION OF EMBODIMENTS

Hereinafter, description will be made on present embodiments using diagrams. In drawings, the same or the corresponding elements are denoted by the same reference signs. In description of the embodiments, explanation of the same or the corresponding elements is appropriately omitted or simplified.

### First Embodiment

### ***Description of Configuration***

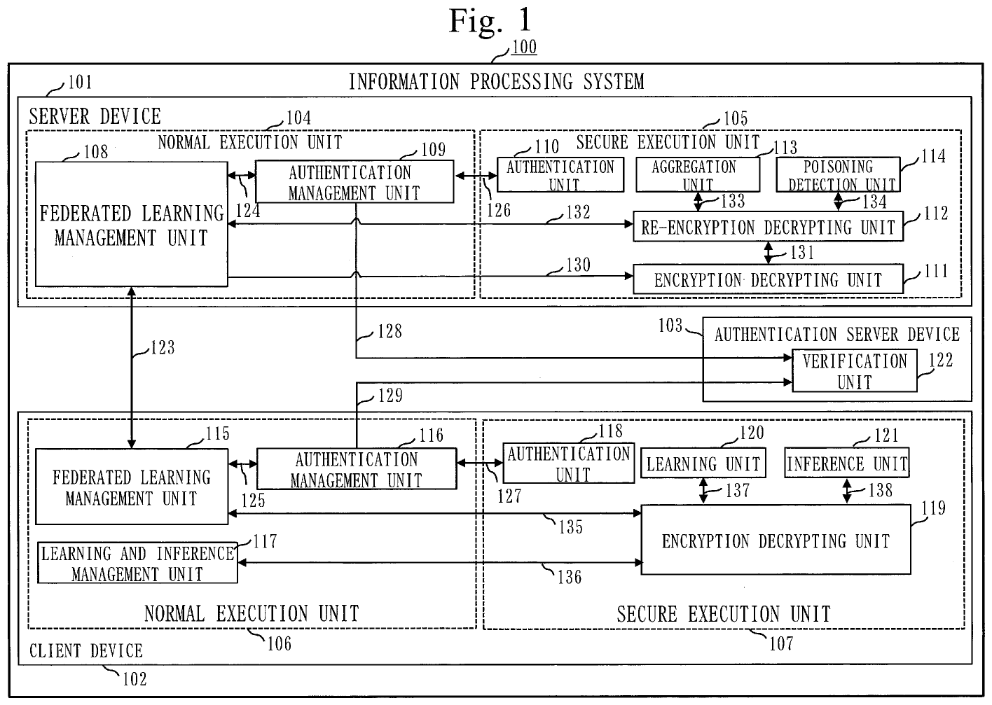

FIG. 1 is a diagram illustrating a configuration example of an information processing system 100 according to the present embodiment.

The information processing system 100 includes a server device 101, a client device 102 and an authentication server device 103. There are a plurality of client devices 102. The server device is also referred to as a server unit. The client device is also referred to as a client unit. The authentication server device is also referred to as an authentication server unit.

In the information processing system 100, the server device 101 and the client device 102 exchange model information used for learning with each other.

The model information includes a client model and a global model. The client model is a learning model provided to the server device 101 from the client device 102. The global model is a learning model distributed to the client devices 102 from the server device 101. The global model is generated by aggregating the client models collected from the client devices 102.

Each of the server device 101, the client devices 102 and the authentication server device 103 is a computer, which communicates information via a network.

Herein, the server device 101, the client devices 102 and the authentication server device 103 may be installed in respective computers. Otherwise, the server device 101, the client devices 102 and the authentication server device 103 may be installed in one computer, and three computers may be virtually configured. Meanwhile, a part of the server device 101, the client devices 102 and the authentication server device 103, such as the server device 101 and the authentication server device 103, may be installed in one computer, and a plurality of computers may be virtually configured.

In the description below, each of the server device 101, the client devices 102 and the authentication server device 103 may be called each device of the information processing system 100.

Each device of the information processing system 100 is a computer. Each device of the information processing system 100 includes a processor, and further includes other hardware components such as a memory unit, an auxiliary storage device, an input interface, an output interface and a communication device. The processor is connected to the other hardware components via signal lines, and controls these other hardware components.

Each device of the server device 101 and the client devices 102 includes a normal execution unit being a normal execution environment and a secure execution unit being a secure execution environment, as virtually separated execution environments. The virtually separated execution environments will be described below.

The server device 101 includes the normal execution unit 104 and the secure execution unit 105 as functional elements. The normal execution unit 104 includes a federated learning management unit 108 and an authentication management unit 109. The secure execution unit 105 includes an authentication unit 110, an encryption decrypting unit 111, a re-encryption decrypting unit 112, an aggregation unit 113 and a poisoning detection unit 114.

Each of the normal execution unit 104 and the secure execution unit 105 includes a storage unit, not shown in the diagrams. The storage units store information such as client models, a global model, a key, authentication information and the like.

When it is described “stored in the normal execution unit” or “placed in the normal execution unit” in the description below, the description shall mean “stored in the storage unit assigned to the normal execution unit” or “stored in the storage unit assigned to the normal execution unit”. Further, when it is described “stored in the secure execution unit” or “placed in the secure execution unit”, the description shall mean “stored in the storage unit assigned to the secure execution unit” or “placed in the storage unit assigned to the secure execution unit”. The same is true of the client devices 102 and the authentication server device 103 below.

The client device 102 includes the normal execution unit 106 and the secure execution unit 107 as functional elements. The normal execution unit 106 includes a federated learning management unit 115, an authentication management unit 116 and a learning and inference management unit 117. The secure execution unit 107 includes an authentication unit 118, an encryption decrypting unit 119, a learning unit 120 and an inference unit 121.

Each of the normal execution unit 106 and the secure execution unit 107 includes a storage unit, not shown in the diagrams. The storage unit stores information such as client models, a global model, a key and authentication information used for information processing.

The authentication server device 103 includes a verification unit 122 as a functional element.

The authentication server device 103 includes a storage unit, not shown in the diagrams. The storage unit stores information such as authentication information verified by the verification unit 122.

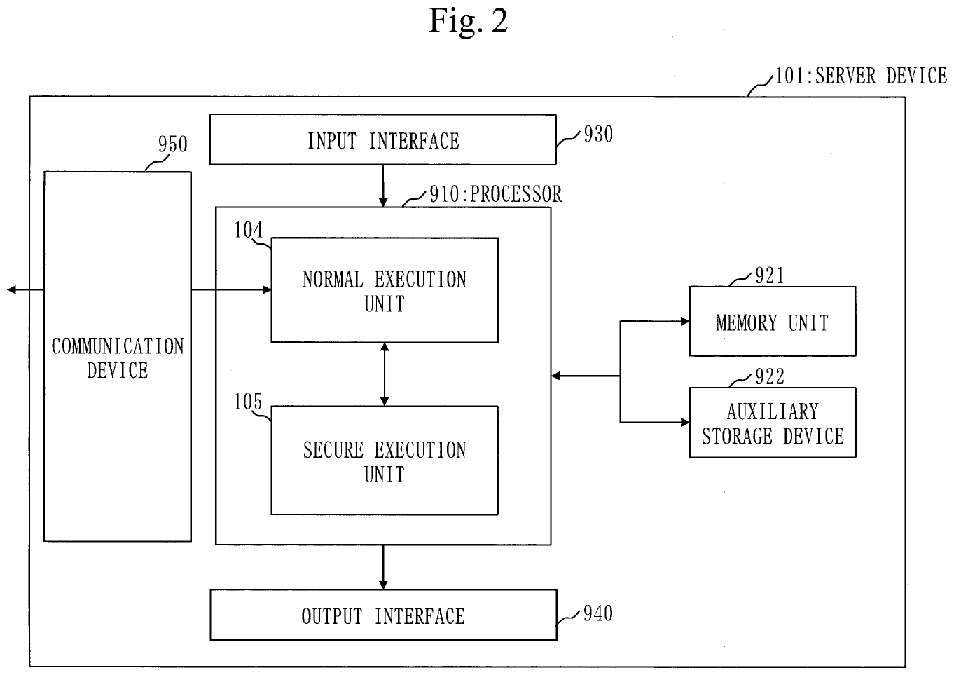

FIG. 2 is a diagram illustrating an example of a hardware configuration of the server device 101 according to the present embodiment.

Description will be made on a configuration example of hardware components of each device of the information processing system 100 by taking the server device 101 in FIG. 2 for example. Since an example of a hardware configuration of the client device 102 and the authentication server device 103 is the same as that of the server device 101, the description is omitted.

The server device 101 is a computer. The server device 101 includes a processor 910, and further includes other hardware components such as a memory unit 921, an auxiliary storage device 922, an input interface 930, an output interface 940 and a communication device 950. The processor 910 is connected to the other hardware components via signal lines, and controls these other hardware components.

In the server device 101, the functions of the normal execution unit 104 and the secure execution unit 105 are realized by software. A storage unit may be provided in the memory unit 921. A storage unit may be provided in the auxiliary storage device 922, or may be dispersedly provided in the memory unit 921 and the auxiliary storage device 922.

The processor 910 is a device to execute an information processing program in the server device 101. The information processing program is a program to realize the functions of each device of the information processing system 100.

The processor 910 is an IC to execute arithmetic processing. A concrete example of the processor 910 is a CPU, a DSP or a GPU. IC is an abbreviation for Integrated Circuit. CPU is an abbreviation for Central Processing Unit. DSP is an abbreviation for Digital Signal Processor. GPU is an abbreviation for Graphics Processing Unit.

The memory unit 921 is a storage device to store data temporarily. A concrete example of the memory unit 921 is an SRAM or a DRAM. SRAM is an abbreviation for Static Random Access Memory. DRAM is an abbreviation for Dynamic Random Access Memory.

The auxiliary storage device 922 is a storage device to store data. A concrete example of the auxiliary storage device 922 is an HDD. Further, the auxiliary storage device 922 may be a portable recording medium such as an SD (registered trademark) memory card, a CF, a NAND flash, a flexible disk, an optical disk, a compact disk, a Blue-ray (registered trademark) disk, or a DVD. HDD is an abbreviation for Hard Disk Drive. SD (registered trademark) is an abbreviation for Secure Digital. CF is an abbreviation for “CompactFlash (registered trademark)”. DVD is an abbreviation for Digital Versatile Disk.

The input interface 930 is a port connected to an input device such as a mouse, a keyboard or a touch panel. The input interface 930 is a USB terminal, for example. The input interface 930 may be a port connected to a LAN. USB is an abbreviation for Universal Serial Bus. LAN is an abbreviation for Local Area Network.

The output interface 940 is a port connected to a cable of an output device such as a display. The output interface 940 is, for example, a USB terminal or an HDMI (registered trademark) terminal. The display is, for example, an LCD. The output interface 940 is also called an indicator interface. HDMI (registered trademark) is an abbreviation for High Definition Multimedia Interface. LCD is an abbreviation for Liquid Crystal Display.

The communication device 950 includes a receiver and a transmitter. The communication device 950 is connected to a communication network such as a LAN, the Internet or a telephone line. The communication device 950 is, for example, a communication chip or an NIC. NIC is an abbreviation for Network Interface Card.

The information processing program is executed by the server device 101. The information processing program is read into the processor 910, and is executed by the processor 910. The memory unit 921 stores not only the information processing program but also an OS (operating system). The processor 910 executes the information processing program while executing the OS. The information processing program and the OS may be stored in the auxiliary storage device 922. The information processing program and the OS stored in the auxiliary storage device 922 are loaded into the memory unit 921, and executed by the processor 910. A part or the whole of the information processing program may be incorporated in the OS.

The server device 101 may include a plurality of processors to replace the processor 910. The plurality of processors share execution of the information processing program. Each processor is a device to execute the information processing program as with the processor 910.

The data, information, signal values and variable values used, processed or output by the information processing program are stored in the memory unit 921, the auxiliary storage device 922 or a register or a cache memory device inside the processor 910.

“Unit” of each unit of the normal execution unit 104 and the secure execution unit 105 may be replaced with “circuit”, “step”, “procedure”, “process” or “circuitry”. The information processing program makes a computer execute a normal execution process and a secure execution process. “Process” of the normal execution process and the secure execution process may be replaced with “program”, “program product”, “a computer-readable storage medium storing a program” or “computer-readable recording medium recording a program”. Further, an information processing method is a method performed by executing the information processing program by each device of the information processing system 100.

The information processing program may be provided by being stored in a computer-readable recording medium. Further, the information processing program may be provided as a program product.

### ***Description of Function***

Next, description will be made on the function of each device in the information processing system 100 using FIG. 1.

The information processing system 100 illustrated in FIG. 1 is obtained by adding the authentication server device 103 to an information processing system in a distributed machine learning system represented by federated learning, which is configured by the server device 101 and the client devices 102.

Each device of the server device 101 and the client devices 102 includes a normal execution unit being a normal execution environment and a secure execution unit being a secure execution environment, as virtually separated execution environments.

It is possible to virtually separate the server device 101 into the normal execution unit 104 and the secure execution unit 105.

In the server device 101, the normal execution unit 104 includes the federated learning management unit 108 and the authentication management unit 109.

The federated learning management unit 108 manages execution of the distributed machine learning represented by federated learning.

The authentication management unit 109 verifies validity of the secure execution unit 105.

Further, in the server device 101, the secure execution unit 105 includes the authentication unit 110, the encryption decrypting unit 111, the re-encryption decrypting unit 112, the aggregation unit 113 and the poisoning detection unit 114. The authentication unit 110 provides authentication information to verify validity of the secure execution unit 105.

The encryption decrypting unit 111 performs encryption processing or decryption processing of model information to be communicated with the client devices 102. The model information to be communicated with the client devices 102 is the client models and the global model.

The re-encryption decrypting unit 112 performs re-encryption processing or decryption processing of information to be communicated with the normal execution unit 104.

The aggregation unit 113 aggregates the client models.

The poisoning detection unit 114 detects poisoning of a client model.

It is possible to virtually separate the client device 102 into the normal execution unit 106 and the secure execution unit 107.

In the client device 102, the normal execution unit 106 includes the federated learning management unit 115, the authentication management unit 116 and the learning and inference management unit 117.

The federated learning management unit 115 manages execution of distributed machine learning represented by federated learning.

The authentication management unit 116 verifies validity of the secure execution unit 107.

The learning and inference management unit 117 manages execution of learning and inference of the model information.

Further, in the client device 102, the secure execution unit 107 includes the authentication unit 118, the encryption decrypting unit 119, the learning unit 120 and the inference unit 121.

The authentication unit 118 provides authentication information to verify the validity of the secure execution unit 107.

The encryption decrypting unit 119 performs encryption processing or decryption processing of the model information to be communicated with the server device 101. The model information communicated with the server device 101 is the client models or the global model.

The learning unit 120 executes learning of the model information.

The inference unit 121 executes inference using the model information.

The authentication server device 103 includes the verification unit 122.

The verification unit 122 verifies each piece of authentication information of the secure execution unit 105 and the secure execution unit 107.

Hereinafter, there is a case wherein the secure execution unit 105 of the server device 101 and the secure execution unit 107 of the client device 102, for example, are described. In this case, the names of components may be omitted in such a manner as the secure execution units 105 and 107, the secure execution unit 105 or 107, or the secure execution units 105, 107.

By making the information processing system 100 of FIG. 1 have the configuration as described above, the client models and the global model are protected, and the validity of each of the secure execution units 105 and 107, and poisoning of a client model are detected. In this manner, federated learning in consideration of security and privacy is realized.

### ***Detailed Description of Function***

Next, the function of each device in the information processing system 100 will be described in detail using FIG. 1.

A distributed machine learning algorithm represented by federated learning is executed by a communication 123 between the federated learning management units 108 and 115 respectively of the server device 101 and the client device 102. It is assumed that there are a plurality of the client devices 102.

Virtual separation of the normal execution units 104 and 106 from the secure execution units 105 and 107 is realized by a TEE technique such as Arm Trustzone or Intel (registered trademark) SGX.

The federated learning management units 108 and 115 perform collection of the client models for federated learning, or distribution of the global model. Further, the federated learning management units 108 and 115 verify validity of the respective secure execution units 105 and 107 at the authentication management units 109 and 116 (processes 124, 125).

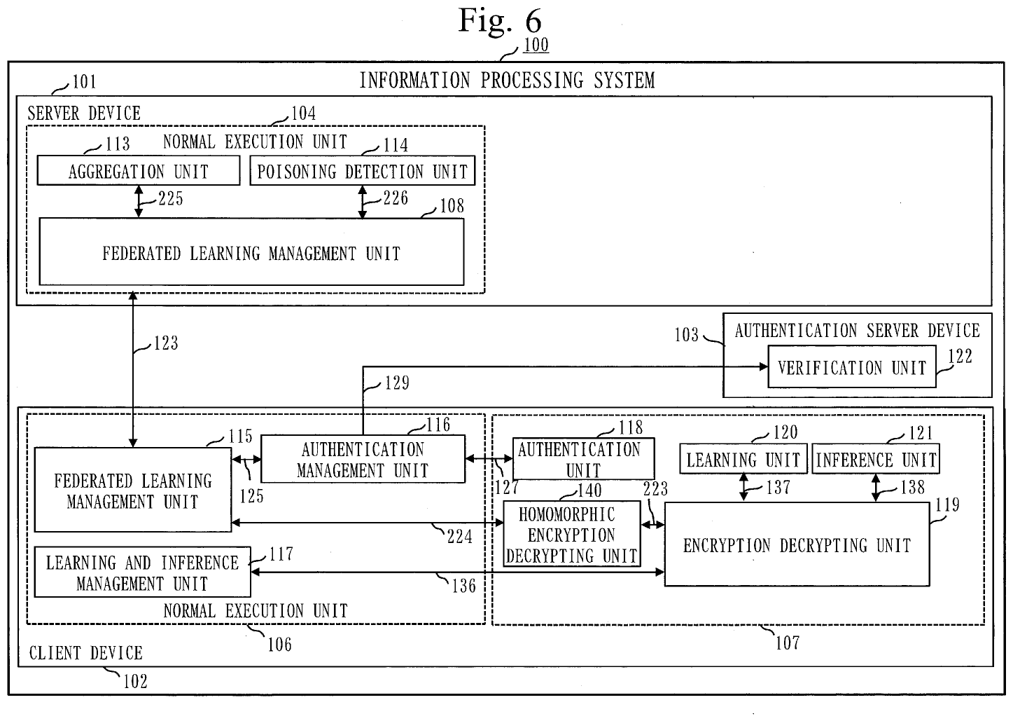

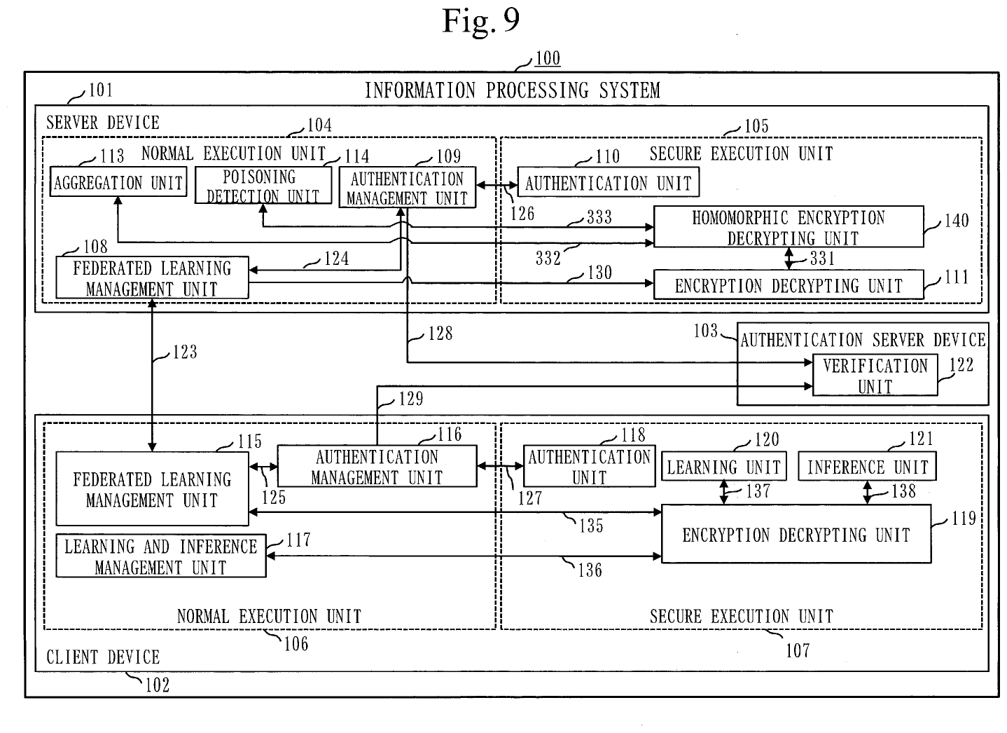

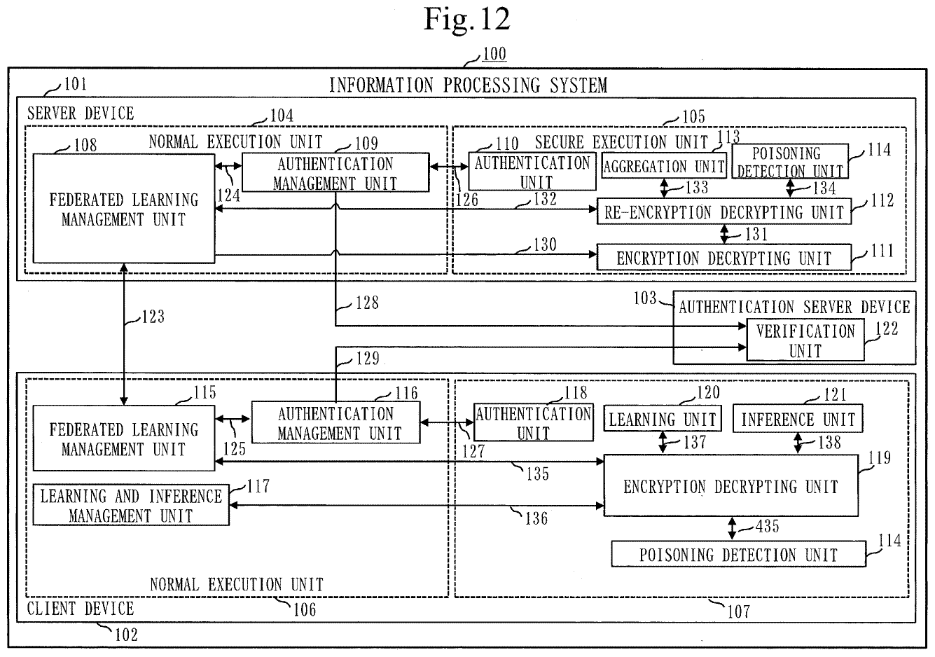

In FIG. 1, numeral references are applied to the arrows between the components. The arrows illustrate communications between the components. In the following description, the communications illustrated by these arrows are called “processes”. The same is the case with FIG. 6, FIG. 9 and FIG. 12.

The authentication management units 109 and 116 obtain authentication information to verify the validity of the secure execution units 105 and 107 from the authentication units 110 and 118 in the secure execution units 105 and 107 (processes 126, 127).

The authentication units 110 and 118 output authentication information (processes 126, 127). The authentication information is, for example, a hash value and a signature of the secure execution unit activated. Authentication of the secure execution units 105 and 107 is realized by a Remote Attestation technique, for example.

Description will be made on the functional elements of the authentication server device 103.

The verification unit 122 obtains authentication information from each of the authentication management units 109 and 116, and verifies whether each of the secure execution units 105 and 107 is activated correctly (processes 128, 129).

Description will be made on the functional elements of the server device 101. The encryption decrypting unit 111 performs decryption processing of the client models collected from the client devices 102 by the federated learning management unit 108, for each client (process 130). Further, the encryption decrypting unit 111 performs encryption processing of the global model distributed from the federated learning management unit 108 to the client devices 102, for each client (process 130).

The re-encryption decrypting unit 112 performs re-encryption processing of the client models collected with a temporary common key (processes 131, 132), and stores the client models re-encrypted in the storage unit of the normal execution unit 104. Further, the re-encryption decrypting unit 112 obtains the client models re-encrypted from the normal execution unit 104, and performs decryption processing of the client models (process 132).

The aggregation unit 113 obtains the decrypted client models collected (process 133), and performs aggregation of the decrypted client models. Aggregation is to calculate the mean value of the client models, for example.

The poisoning detection unit 114 obtains the decrypted client models collected (process 134), and performs poisoning detection of a client model. Poisoning detection is, for example, to calculate an inter-model distance between client models, and to detect that a client model is poisoned when the distance is large.

Description will be made on the functional element of the client device 102.

The encryption decrypting unit 119 performs encryption processing of the client model provided by the federated learning management unit 115 to the server device 101 (process 135). Further, the encryption decrypting unit 119 performs decryption processing of the global model distributed from the server device 101 by the federated learning management unit 115 (process 136).

The learning and inference management unit 117 manages execution of learning or inference processing using the global model distributed from the server device 101 (process 136).

The learning unit 120 performs learning using the global model decrypted by the encryption decrypting unit 119, by using the learning and inference management unit 117 (process 137).

The inference unit 121 performs inference using the global model decrypted by the encryption decrypting unit 119, by using the learning and inference management unit 117 (process 138).

The learning and inference management unit 117, the learning unit 120 and the inference unit 121 to execute machine learning operations are not limited to deep learning. For example, the learning and inference management unit 117, the learning unit 120 and the inference unit 121 may be arithmetic operations using methods such as regression method, Decision tree learning, Bayesian inference method, or clustering.

### ***Description of Operation***

Next, description will be made on the operation of the information processing system 100 according to the present embodiment. The operation procedure of the information processing system 100 corresponds to an information processing method. Further, a program to realize the operation of the information processing system 100 corresponds to an information processing program.

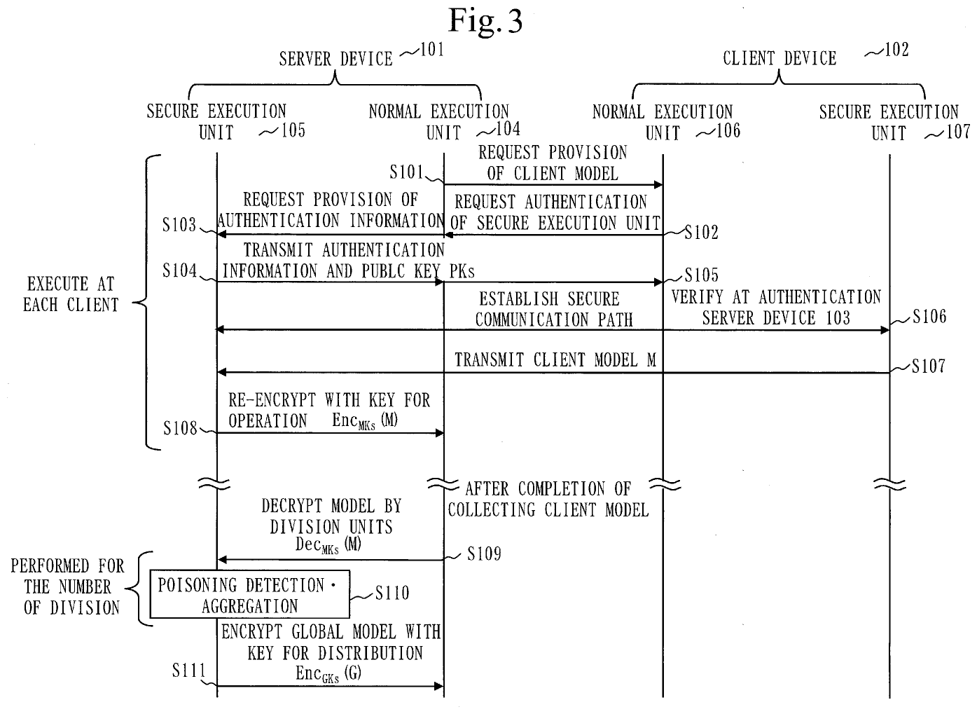

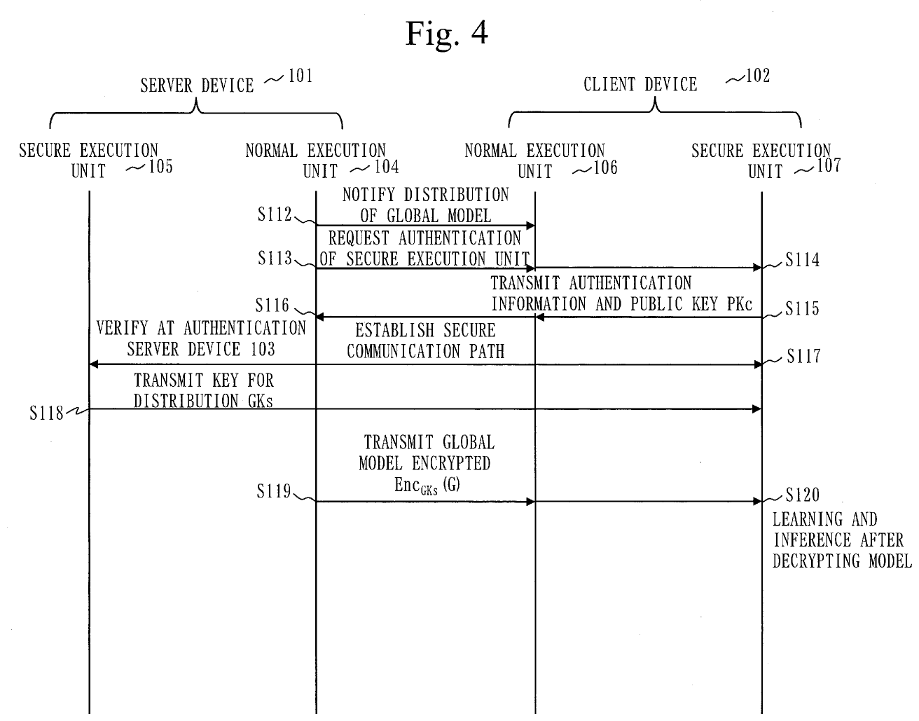

FIG. 3 is a sequence diagram illustrating an operation of collecting client models in the information processing system 100 according to the present embodiment. FIG. 4 is a sequence diagram illustrating an operation of distributing the global model in the information processing system 100 according to the present embodiment.

This sequence diagram illustrates communications between the server device 101 and the client device 102 in the information processing system 100 by dividing them by the normal execution units 104 and 106, and the secure execution units 105 and 107.

### <Collecting Client Model>

Description will be made on the operation of collecting processing of a client model in the information processing system 100 using FIG. 3.

First, the normal execution units 104 and 106 of respective devices being the server device 101 and the client device 102 authenticate validity of activating the secure execution unit in each device with each other. When the validity of activating the secure execution device in each device is authenticated, a secure communication path to receive and transmit encrypted data between the secure execution units of the respective devices is established. That is, the secure communication path is established between secure execution environments of the respective devices.

Specifically, as follows.

In Step S101, the normal execution unit 104 of the server device 101 transmits a provision request of a client model to the normal execution unit 106 of the client device 102.

In Step S102, the normal execution unit 106 of the client device 102 transmits an authentication request of the secure execution unit to the normal execution unit 104 of the server device 101 in order to verify the validity of the secure execution unit 105 of the server device 101.

In Step S103, the normal execution unit 104 of the server device 101 transmits a provision request of authentication information to the secure execution unit 105 of the server device 101.

In Step S104, the secure execution unit 105 of the server device 101 transmits the authentication information and a public key PKs to the normal execution unit 104 of the server device 101.

In Step S105, the normal execution unit 104 of the server device 101 transfers the authentication information and the public key PKs to the normal execution unit 106 of the client device 102. The normal execution unit 106 of the client device 102 transmits a verification request of the authentication information to the verification unit 122 of the authentication server device 103. The verification unit 122 of the authentication server device 103 transmits a verification result to the normal execution unit 106 of the client device 102. The normal execution unit 106 of the client device 102 transmits the public key PKs to the secure execution unit 107 of the client device 102 when the validity of the secure execution unit 105 of the server device 101 is verified.

In Step S106, the secure execution unit 107 of the client device 102 performs key exchange using the public key PKs with the secure execution unit 105 of the server device 101, and establishes a secure communication path wherein the transmission and reception data is encrypted.

In Step S107, the secure execution unit 107 of the client device 102 transmits a client model M to the secure execution unit 105 of the server device 101 on the secure communication path.

The server device 101 operates as follows in order to suppress memory consumption in the secure execution unit 105.

The secure execution unit 105 of the server device 101 decrypts the client model provided via the secure communication path from the client device 102. Then, the secure execution unit 105 of the server device 101 re-encrypts the client model decrypted, and transmits the client model re-encrypted to the normal execution unit 104 of the server device 101.

The normal execution unit 104 of the server device 101 stores the client model re-encrypted in the storage unit.

Specifically, as follows.

In Step S108, the secure execution unit 105 of the server device 101 re-encrypts the client model M with a temporary key MKs for arithmetic operation. Specifically, the secure execution unit 105 of the server device 101 decrypts the client model M received from the client device 102 in Step S107, and re-encrypts the temporary key MKs for arithmetic operation. Then, the secure execution unit 105 of the server device 101 transmits a client model EncMKs (M) re-encrypted with the temporary key MKs to the normal execution unit 104 of the server device 101. The normal execution unit 104 of the server device 101 stores the client model EncMKs (M) re-encrypted with the temporary key MKs in the storage unit.

By the process of Step S108, the server device 101 can suppress power consumption in the secure execution unit 105.

In the information processing system 100, the processes of Step S101 through Step S108 are performed in each client device 102, and the client model from each client device 102 is collected. After completing collection of all the client models, the procedure proceeds to the next step.

### <Aggregation of Client Model>

Next, in the server device 101, the client models are aggregated, and a global model is generated.

The secure execution unit 105 of the server device 101 performs aggregation processing to decrypt and aggregate model information provided via the secure communication paths from the client devices 102.

The secure execution unit 105 of the server device 101 encrypts the model information obtained by aggregation processing, and transmits the model information encrypted to the normal execution unit 104 of the server device 101. The model information is client models.

The normal execution unit 104 of the server device 101 stores the model information obtained by aggregation processing, as the global model, in an encrypted state in the storage unit.

Specifically, as follows.

Next, in Step S109, the normal execution unit 104 of the server device 101 transmits the client model EncMKs (M) re-encrypted to the secure execution unit 105 of the server device 101. Specifically, the normal execution unit 104 of the server device 101 divides all the client models EncMKs (M) re-encrypted, and transmits all the client models EncMKs (M) re-encrypted to the secure execution unit 105 of the server device 101. The secure execution unit 105 of the server device 101 divides all the client models EncMKs (M) re-encrypted into parts, and transmits all the client models EncMKs (M) divided.

The secure execution unit 105 of the server device 101 decrypts the client models EncMKs (M) divided. The secure execution unit 105 of the server device 101 stores the client model DecMKs (M) decrypted. The client models DecMKs (M) stored in the secure execution unit 105 are a part of all the client models.

By the process of Step S109, the server device 101 can suppress memory consumption in the secure execution unit 105.

The secure execution unit 105 of the server device 101 generates a global model by performing aggregation processing for the client models transmitted from the normal execution unit 104 of the server device 101. In this case, the secure execution unit 105 of the server device 101 performs poisoning detection processing for the client models, and a client model for which poisoning is detected is not aggregated.

Specifically, as follows.

In Step S110, the secure execution unit 105 of the server device 101 performs poisoning detection and aggregation using the client models DecMKs (M) decrypted.

The secure execution unit 105 of the server device 101 performs aggregation processing for each client model DecMKs (M) divided.

Further, the secure execution unit 105 of the server device 101 performs poisoning detection processing to detect whether the client model DecMKs (M) decrypted has been poisoned. Then, the secure execution unit 105 of the server device 101 does not aggregate a client model which has been detected to be poisoned.

In the information processing system 100, the process from Step S109 through Step S110 is repeatedly performed for division units of all the client models. After aggregation of all the client models is completed, the procedure proceeds to the next Step S111. In Step S110, it may be possible to aggregate the client models of the number of division aggregated by division units, and generate one global model. Otherwise, it may be possible to regard client models of the number of division aggregated by division units as global models of the number of division.

Lastly, the secure execution unit 105 of the server device 101 encrypts the global model, and transmits the global model encrypted to the normal execution unit 104 of the server device 101.

The normal execution unit 104 of the server device 101 stores the global model encrypted in the storage unit.

Specifically, as follows.

In Step S111, the secure execution unit 105 of the server device 101 encrypts the client models aggregated with the temporary key GKs for distribution as a global model G. The secure execution unit 105 of the server device 101 transmits the global model EncGKs (G) encrypted to the normal execution unit 104 of the server device 101. The normal execution unit 104 of the server device 101 stores the global model EncGKs (G) encrypted.

### <Global Model Distribution>

Description will be made on a global model distribution process in the information processing system 100 using FIG. 4.

In Step S112, the normal execution unit 104 of the server device 101 transmits a distribution notification of the global model to the normal execution unit 106 of the client device 102. Otherwise, it may be possible to transmit a distribution request of the global model to the normal execution unit 104 of the server device 101 from the normal execution unit 106 of the client device 102.

In Step S113, the normal execution unit 104 of the server device 101 transmits ana authentication request of the secure execution unit to the normal execution unit 106 of the client device 102 in order to verify the validity of the secure execution unit 107 of the client device 102.

In Step S114, the normal execution unit 106 of the client device 102 transmits a provision request of the authentication information to the secure execution unit 107 of the client device 102.

In Step S115, the secure execution unit 107 of the client device 102 transmits the authentication information and the public key PKc to the normal execution unit 106 of the client device 102.

In Step S116, the normal execution unit 106 of the client device 102 transfers the authentication information and the public key PKc to the normal execution unit 104 of the server device 101. The normal execution unit 104 of the server device 101 transmits a verification request of the authentication information to the verification unit 122 of the authentication server device 103. The verification unit 122 of the authentication server device 103 transmits a verification result to the normal execution unit 104 of the server device 101. The normal execution unit 104 of the server device 101 transmits the public key PKc to the secure execution unit 105 of the server device 101 when the validity of the secure execution unit 107 of the client device 102 is verified.

In Step S117, the secure execution unit 105 of the server device 101 performs key exchange using the public key PKc with the secure execution unit 107 of the client device 102, and establishes a secure communication path wherein transmission and reception data is encrypted.

In Step S118, the secure execution unit 105 of the server device 101 transmits the temporary key GKs for distribution to the secure execution unit 107 of the client device 102 on the secure communication path.

In Step S119, the normal execution unit 104 of the server device 101 transmits the global model EncGKs (G) encrypted to the normal execution unit 106 of the client device 102.

Lastly, in Step S120, the normal execution unit 106 of the client device 102 transmits the global model EncGKs (G) encrypted to the secure execution unit 107 of the client device 102 in order to perform learning or inference processing. The secure execution unit 107 of the client device 102 decrypts the global model EncGKs (G) encrypted with the temporary key GKs for distribution, and performs learning or inference processing.

### Description of Effect of Present Embodiment

As describe above, by the information processing system 100 according to the present embodiment, the client models and the global model are encrypted and communicated between the server device 101 and the client devices 102. Further, the client models and the global model are decrypted only by the secure execution units 105 and 107. Therefore, by the information processing system 100 according to the present embodiment, it is possible to ensure privacy of the clients and security of the global model.

In the information processing system 100 according to the present embodiment, the validity of the secure execution units 105 and 107 of the server device 101 and the client device 102 is verified. Therefore, by the information processing system 100 according to the present embodiment, it is possible to prevent invalid processing in an invalid server device 101 and an invalid client device 102.

Further, by detecting model poisoning at the time of aggregating client models, it is possible to prevent learning obstruction from a malicious client. As for aggregation of the client models and the model poisoning detection in the secure execution units 105 of the server device 101, memory saving by deploying and executing division is realized since there are limits on the memory resources of the secure execution units 105.

The client models and the global model are stored in the normal execution units in an encrypted state; therefore, it is possible to reduce loads on the resources of the secure execution units.

The global model is encrypted with the temporary key for distribution aside from an encryption key for a client model. In this manner, it is possible for a model vendor to own the temporary key for distribution, and adjust the global model. In this case, since the model vendor does not own the encryption key for the client model, the privacy of the client is protected.

### ***Another Configuration***

In the present embodiment, the functions of each device of the server device 101, the client devices 102 and the authentication server device 103 are realized by software. As a variation, the functions of each device of the server device 101, the client devices 102 and the authentication server device 103 may be realized by hardware components.

Specifically, the information processing system 100 includes an electronic circuit 909 in place of the processor 910.

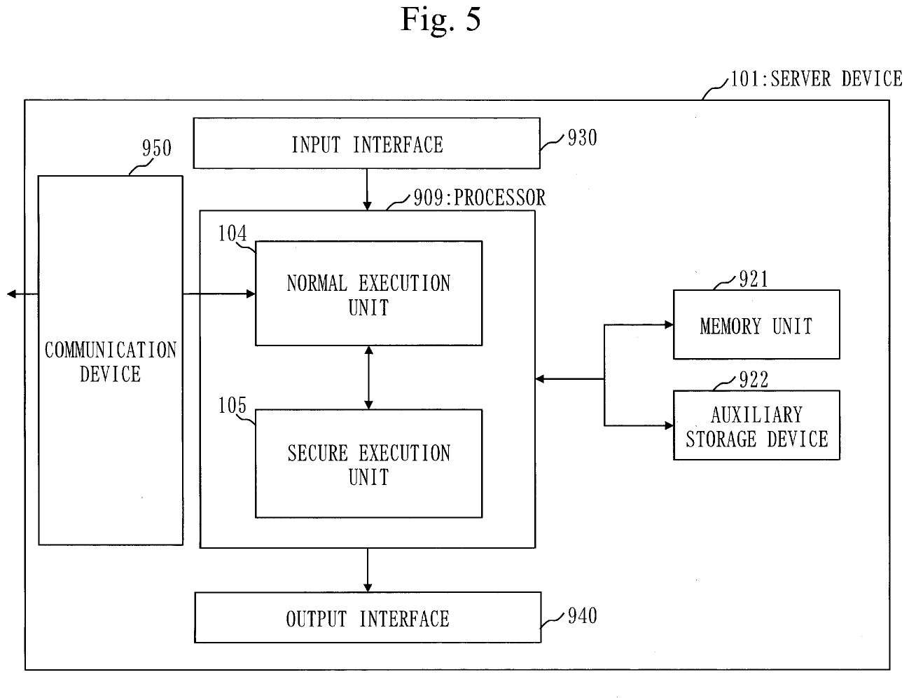

FIG. 5 is a diagram illustrating an example of a hardware configuration of the information processing system 100 according to a variation of the present embodiment.

The electronic circuit 909 is a dedicated electronic circuit to realize the functions of each device of the server device 101, the client devices 102 and the authentication server device 103. The electronic circuit 909 is, for example, a single circuit, a composite circuit, a processor made into a program, a processor made into a parallel program, a logic IC, a GA, an ASIC or an FPGA. GA is an abbreviation for “Gate Array”. ASIC is an abbreviation for “Application Specific Integrated Circuit”.

FPGA is an abbreviation for “Field Programmable Gate Array”.

The functions of each device of the server device 101, the client devices 102 and the authentication server device 103 may be realized by one electronic circuit, or may be realized by a plurality of electronic circuits dispersedly.

As another variation, a part of the functions of each device of the server device 101, the client devices 102 and the authentication server device 103 may be realized by an electronic circuit, and the remaining functions may be realized by software. Further, a part or all of the functions of each device of the server device 101, the client devices 102 and the authentication server device 103 may be realized by firmware.

Each of the processors and electronic circuits is also called processing circuitry. That is, the functions of each device of the server device 101, the client devices 102 and the authentication server device 103 are realized by processing circuitry.

### Second Embodiment

In the present embodiment, description will be made mainly on points different from First Embodiment, and points added to First Embodiment.

In the present embodiment, components having functions similar to those in First Embodiment are denoted by the same reference signs, whereof description is omitted.

In First Embodiment, the server device 101 includes a virtual separation execution environment by TEE.

Meanwhile, in the present embodiment, description is made on a state using homomorphic encryption which enables arithmetic operation in an encrypted state when the server device 101 does not have a virtual separation execution environment by TEE.

### ***Description of Configuration***

FIG. 6 is a diagram illustrating a configuration example of the information processing system 100 according to the present embodiment.

In the present embodiment, the server device 101 includes only the normal execution unit 104 being a normal execution environment. The normal execution unit 104 of the server device 101 includes the federated learning management unit 108, the aggregation unit 113 and the poisoning detection unit 114.

Further, the client device 102 of the present embodiment includes a configuration capable of virtually separating the normal execution unit 106 and the secure execution unit 107 as with First Embodiment.

The configuration of the normal execution unit 106 of the client device 102 is similar to that of First Embodiment.

The secure execution unit 107 of the client device 102 includes a homomorphic encryption decrypting unit 140 in addition to a configuration similar to that of First Embodiment.

The homomorphic encryption decrypting unit 140 performs homomorphic encryption and decryption processing of model information to be communicated with the server device 101. The model information is client models and a global model.

In the present embodiment, the encryption decrypting unit 119 of the client device 102 performs encryption and decryption processing of model information to be communicated with the server device 101.

The authentication server device 103 includes the verification unit 122 as with First Embodiment. In the present embodiment, the verification unit 122 verifies authentication information of the secure execution unit 107.

The information processing system 100 of FIG. 6 protects the client models and the global model, and verifies the validity of the secure execution unit 107 by being configured as described above. Further, the information processing system 100 of FIG. 6 performs poisoning detection and aggregation of the client models while the client models remain homomorphic encrypted in the normal execution unit 104 of the server device 101. In this manner, federated learning in consideration of security and privacy is realized.

An example of the hardware configuration of the information processing system 100 according to the present embodiment is similar to that of First Embodiment.

### ***Description of Function***

The secure execution unit of the client device 102 performs homomorphic encryption of the client models being the model information to be provided to the server device 101.

The normal execution unit 104 of the server device 101 performs aggregation processing to aggregate the client models homomorphic encrypted while the client models remain homomorphic encrypted. Then, the normal execution unit 104 of the server device 101 stores the global model obtained by aggregation processing in the storage unit while the global model remains homomorphic encrypted.

Further, the normal execution unit 104 of the server device 101 performs poisoning detection processing of the client models homomorphic encrypted to detect poisoning while the client models remain homomorphic encrypted.

### ***Detailed Description of Function***

Next, the functions of each device of the information processing system 100 will be described in more detail using FIG. 6. The parts described in First Embodiment may be omitted.

A distributed machine learning algorithm represented by federated learning is executed by the communication 123 between the federated learning management units 108 and 115 respectively of the server device 101 and the client device 102. It is assumed that there are a plurality of the client devices 102.

Virtual separation of the normal execution unit 106 and the secure execution unit 107 of the client device 102 is realized by, for example, a TEE technique such as Arm Trustzone or Intel (registered trademark) SGX.

The federated learning management units 108 and 115 perform collection of the client models for federated learning, or distribution of the global model. Further, the federated learning management unit 115 of the client device 102 verifies validity of the secure execution unit 107 by the authentication management unit 116 (process 125).

Description will be made on components to verify validity of the secure execution unit 107.

The authentication management unit 116 obtains authentication information to verify the validity of the secure execution unit 107, from the authentication unit 118 in the secure execution unit 107 (process 127).

The authentication unit 118 outputs the authentication information (process 127). The authentication information is, for example, a hash value and a signature of a secure execution unit activated. Authentication of the secure execution unit 107 is realized by a Remote Attestation technique, for example.

The verification unit 122 obtains the authentication information from the authentication management unit 116, and verifies whether the secure execution unit 107 is activated correctly (process 129).

Description will be made on the components provided in the server device 101.

The aggregation unit 113 obtains the client models homomorphic encrypted, which have been collected by the federated learning management unit 108 (process 225), and aggregates the client models. Aggregation is to calculate the mean value of the client models, for example. However, the operation shall be an arithmetic operation wherein the client models remain homomorphic encrypted.

The poisoning detection unit 114 obtains the client models homomorphic encrypted, which have been collected by the federated learning management unit 108 (process 226), and performs poisoning detection of the client models. Poisoning detection is, for example, to calculate an inter-model distance between the client models, and to detect that a client model is poisoned when the distance is large. However, since the operation shall be the arithmetic operation wherein the client models remain homomorphic encrypted, judgement of the magnitude of the distance is performed at the client device 102.

Description will be made on the components provided in the client device 102.

The learning and inference management unit 117 manages execution of learning or inference processing using the global model distributed from the server device 101 (process 136).

The homomorphic encryption decrypting unit 140 performs homomorphic encryption processing of the client models provided to the server device 101 by the federated learning management unit 115 (process 223). Further, the homomorphic encryption decrypting unit 140 performs decryption processing of the global model homomorphic encrypted, which has been distributed from the server device 101 (process 224).

The encryption decrypting unit 119 re-encrypts the global model for which homomorphic encryption has been decrypted. Further, the encryption decrypting unit 119 decrypts the model information encrypted (process 223).

The learning unit 120 performs learning using the global model decrypted by the encryption decrypting unit 119, by using the learning and inference management unit 117 (process 137).

The inference unit 121 performs inference using the global model decrypted by the encryption decrypting unit 119, by using the learning and inference management unit 117 (process 138).

### ***Description of Operation***

Next, description will be made on the operation of the information processing system 100 according to the present embodiment. The operation procedure of the information processing system 100 corresponds to an information processing method. Further, the program to realize the operation of the information processing system 100 corresponds to an information processing program.

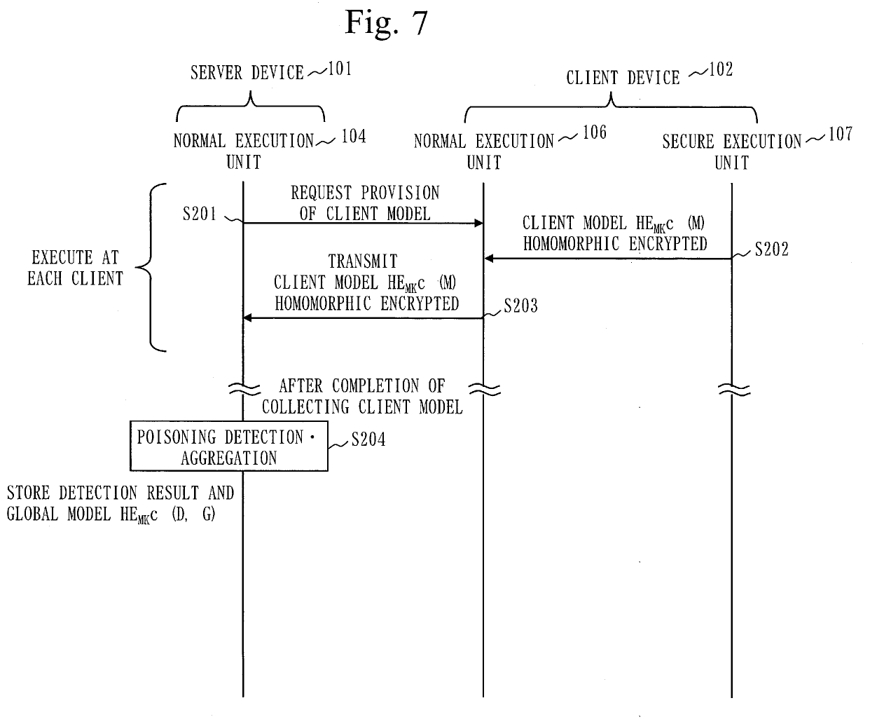

FIG. 7 is a sequence diagram illustrating the operation of collecting client models in the information processing system 100 according to the present embodiment.

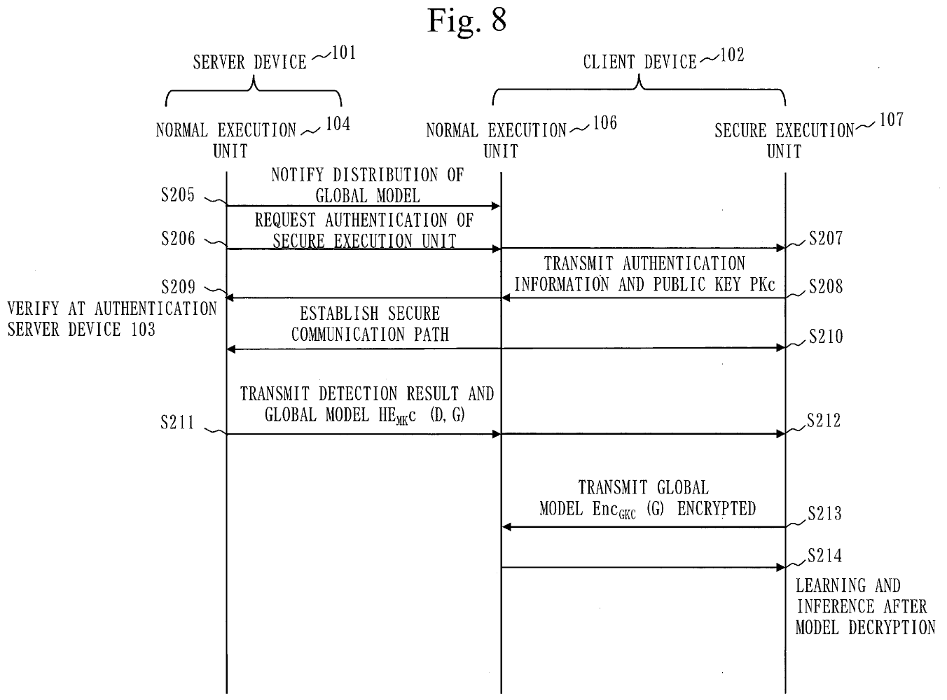

FIG. 8 is a sequence diagram illustrating the operation of distributing a global model in the information processing system 100 according to the present embodiment.

This sequence diagram illustrates communications between the server device 101 and the client device 102 in the information processing system 100 according to the present embodiment by dividing them by the normal execution units 104 and 106, and the secure execution unit 107.

### <Collecting Client Model>

Description will be made on the operation of collecting processing of client models in the information processing system 100 according to the present embodiment using FIG. 7.

In Step S201, the normal execution unit 104 of the server device 101 transmits a provision request of a client model to the normal execution unit 106 of the client device 102.

In Step S202, the normal execution unit 106 of the client device 102 obtains a client model HEMKc (M) homomorphic encrypted from the secure execution unit 107 of the client device 102.

In Step S203, the normal execution unit 106 of the client device 102 transmits the client model HEMKc (M) homomorphic encrypted to the normal execution unit 104 of the server device 101.

Step S201 through Step S203 above are performed at each client, and the server device 101 collects the client models. After completion of all the client models, the next Step S204 is performed.

Lastly, in Step S204, the normal execution unit 104 of the server device 101 performs poisoning detection and aggregation using the client models HEMKc (M) homomorphic encrypted while the client models HEMKc (M) remain encrypted. The normal execution unit 104 of the server device 101 regards the client models aggregated as a global model, and stores a global model HEGKs (G) homomorphic encrypted and a poisoning detection result in the storage unit.

### <Global Model Distribution Process>

Description will be made on the operation of distribution processing of the global model in the information processing system 100 according to the present embodiment using FIG. 8.

In Step S205, the normal execution unit 104 of the server device 101 transmits a distribution notification of the global model to the normal execution unit 106 of the client device 102. It may be possible to transmit the distribution request of the global model from the normal execution unit 106 of the client device 102 to the normal execution unit 104 of the server device 101.

In Step S206, the normal execution unit 104 of the server device 101 transmits an authentication request of the secure execution unit to the normal execution unit 106 of the client device 102 in order to verify validity of the secure execution unit 107 of the client device 102.

In Step S207, the normal execution unit 106 of the client device 102 transmits a provision request of authentication information to the secure execution unit 107 of the client device 102.

In Step S208, the secure execution unit 107 of the client device 102 transmits the authentication information and the public key PKc to the normal execution unit 106 of the client device 102.

In Step S209, the normal execution unit 106 of the client device 102 transfers the authentication information and the public key PKc to the normal execution unit 104 of the server device 101. The normal execution unit 104 of the server device 101 transmits a verification request of the authentication information to the verification unit 122 of the authentication server device 103. The verification unit 122 of the authentication server device 103 transmits a verification result to the normal execution unit 104 of the server device 101. The normal execution unit 104 of the server device 101 transmits the public key PKc to the normal execution unit 104 of the server device 101 when validity of the secure execution unit 107 of the client device 102 is verified.

In Step S210, the normal execution unit 104 of the server device 101 performs key exchange with the secure execution unit 107 of the client device 102 using the public key PKc, and establishes a secure communication path wherein transmission and reception data is encrypted.

In Step S211, the normal execution unit 104 of the server device 101 transmits the global model HEGKs (G) homomorphic encrypted and the poisoning detection result to the secure execution unit 107 of the client device 102 on the secure communication path.

In Step S212, the secure execution unit 107 of the client device 102 decrypts the global model HEGKs (G) homomorphic encrypted and the poisoning detection result. The secure execution unit 107 of the client device 102 encrypts the global model with a key for client model protection GKc if the client model is not poisoned based on the poisoning detection result. Then, the secure execution unit 107 of the client device 102 transmits the global model EncGKc (G) encrypted to the normal execution unit 106 of the client device 102.

Lastly, in Step S214, the normal execution unit 106 of the client device 102 transmits the global model EncGKc (G) encrypted to the secure execution unit 107 of the client device 102 in order to perform learning or inference processing. The secure execution unit 107 of the client device 102 decrypts the global model EncGKc (G) encrypted with the key for client model protection GKc, and performs learning or inference processing.

### Description of Effect of Present Embodiment

As described above, by the information processing system 100 according to the present embodiment, the client models and the global model are communicated between the server device 101 and the client devices 102 in a homomorphic encrypted state. Then, the client models and the global model are calculated in an encrypted state by homomorphic encryption, or decrypted only by the secure execution unit of the client device 102. Therefore, it is possible to ensure privacy of the clients and security of the global model.

Further, the validity of the secure execution units of the client devices 102 is verified. Therefore, it is possible to prevent invalid processing by an invalid client device 102. Further, by confirming the poisoning detection result as well as the global model at the secure execution unit of the client device 102, it is possible to prevent learning obstruction from a malicious client.

Since the client models and the global model are stored in the normal execution units in an encrypted state, it is possible to decrease loads on resources of the secure execution units.

### Third Embodiment

In the present embodiment, description will be made mainly on different points from First Embodiment and Second Embodiment, and points added to First Embodiment and Second Embodiment.

In the present embodiment, the configurations having functions similar to those of First Embodiment and Second Embodiment are denoted by the same reference signs, whereof description is omitted.

In Second Embodiment, description has been made on the state wherein homomorphic encryption enabling operation in an encrypted state when there is no virtual separation execution environment by TEE in the server device 101.

Meanwhile, in the present embodiment, description will be made on a state wherein a virtual separation execution environment by TEE and homomorphic encryption enabling operation in an encrypted state are used simultaneously in the server device 101.

### ***Description of Configuration***

FIG. 9 is a diagram illustrating a configuration example of the information processing system 100 according to the present embodiment.

The server device 101 has a configuration that can be virtually separated into the normal execution unit 104 and the secure execution unit 105 as with First Embodiment.

Further, the client device 102 also has a configuration that can be virtually separated into the normal execution unit 106 and the secure execution unit 107 as with First Embodiment and Second Embodiment.

The normal execution unit 104 of the server device 101 includes the federated learning management unit 108, the authentication management unit 109, the aggregation unit 113 and the poisoning detection unit 114.

The secure execution unit 105 of the server device 101 includes the authentication unit 110, the encryption decrypting unit 111 and the homomorphic encryption decrypting unit 140. In the present embodiment, the homomorphic encryption decrypting unit 140 performs homomorphic encryption and decryption processing of information communicated with the normal execution unit 104 of the server device 101.

The normal execution unit 104 of the client device 102 includes the federated learning management unit 115, the authentication management unit 116 and the learning and inference management unit 117 as with First Embodiment.

The secure execution unit 107 of the client device 102 includes the authentication unit 118, the encryption decrypting unit 119, the learning unit 120 and the inference unit 121 as with First Embodiment.

The authentication server device 103 includes the verification unit 122.

The verification unit 122 verifies authentication information of each of the secure execution unit 105 and the secure execution unit 107.

By employing the structure as described above for the information processing system 100 of FIG. 9, the information processing system 100 protects the client models and the global model, and detects the validity of each of the secure execution units 105 and 107, and poisoning of the client model. In this manner, federated learning in consideration of security and privacy is realized.

An example of a hardware configuration of the information processing system 100 according to the present embodiment is similar to that in First Embodiment.

### ***Description of Function***

The normal execution units 104 and 106 authenticate validity of activating the secure execution units 105 and 107 with each other. When the validity of activating the secure execution units 105 and 107 is authenticated, a secure communication path to transmit and receive data encrypted between the secure execution units 105 and 107 is established.

The secure execution unit 105 of the server device 101 performs homomorphic encryption of the client model being model information provided via the secure communication path from the client device 102. Then, the secure execution unit 105 of the server device 101 stores the model information homomorphic encrypted in the storage unit in a homomorphic encrypted state.

The normal execution unit 104 of the server device 101 performs aggregation processing to aggregate the model information homomorphic encrypted while the model information remains homomorphic encrypted. Then, the normal execution unit 104 of the server device 101 stores the global model being the model information obtained by aggregation processing in an homomorphic encrypted state, in the storage unit.

Further, the normal execution unit 104 of the server device 101 performs poisoning detection processing to detect poisoning of the client models being the model information homomorphic encrypted while the client models remain homomorphic encrypted.

### ***Detailed Description of Function***

Next, functions of each device of the information processing system 100 will be described in more detail using FIG. 9.

A distributed machine learning algorithm represented by federated learning is performed in the communication 123 between the federated learning management units 108 and 115 respectively of the server device 101 and the client device 102. It is assumed that there are a plurality of client devices 102.

Virtual separation of the normal execution unit 106 and the secure execution unit 107 of the client device 102 is realized by a TEE technique, such as Arm Trustzone, or Intel (registered trademark) SGX, for example.

The federated learning management units 108 and 115 verify validity of the secure execution units 105 and 107 with each other respectively at the authentication management units 109 and 116. This processing is similar to that described in First Embodiment.

The encryption decrypting unit 111 performs decryption processing for each of the client models collected from the client devices 102, by the federated learning management unit 108. Otherwise, the encryption decrypting unit 111 performs encryption processing of the global model to be distributed to the client devices 102, for each client, by the federated learning management unit 108 (processing 130).

The homomorphic encryption decrypting unit 140 performs homomorphic encryption processing of the client models collected with a temporary common key (process 331), and stores the client models homomorphic encrypted in the normal execution unit 104. Otherwise, the homomorphic encryption decrypting unit 140 obtains the global model in a homomorphic encrypted state, from the normal execution unit 104, and performs decryption processing of the global model homomorphic encrypted (process 332).

The aggregation unit 113 obtains the client models homomorphic encrypted, which have been collected (process 332), and performs aggregation of the client models.

Aggregation is, for example, to calculate the mean value of the client models. However, in the present embodiment, the operation is performed while the client models remain homomorphic encrypted.

The poisoning detection unit 114 obtains the client models homomorphic encrypted, which have been collected (process 333), and performs poisoning detection of the client models in the homomorphic encrypted state. Poisoning detection is, for example, to calculate an inter-model distance between the client models, and to detect that a client model is poisoned when the distance is large. However, in the present embodiment, the operation shall be arithmetic operation while the client models remain homomorphic encrypted, judgment of the magnitude of the distance is performed after performing decryption at the secure execution unit 105 of the server device 101.

The function to provide the client models at the client devices 102 to the server device 101, and the function to perform learning or inference using the global model distributed from the server device 101 are similar to those described in First Embodiment.

### ***Description of Operation***

Next, description will be made on the operation of the information processing system 100 according to the present embodiment. The operation procedure of the information processing system 100 corresponds to an information processing method. Further, the program to realize the operation of the information processing system 100 corresponds to an information processing program.

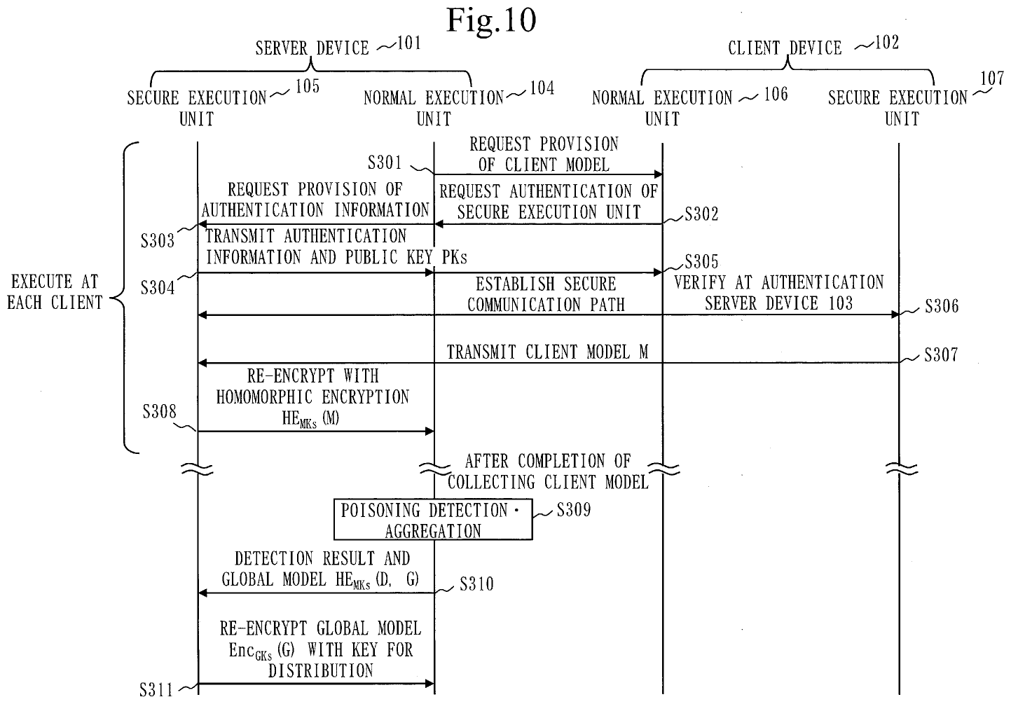

FIG. 10 is a sequence diagram illustrating the operation of collecting client models in the information processing system 100 according to the present embodiment.

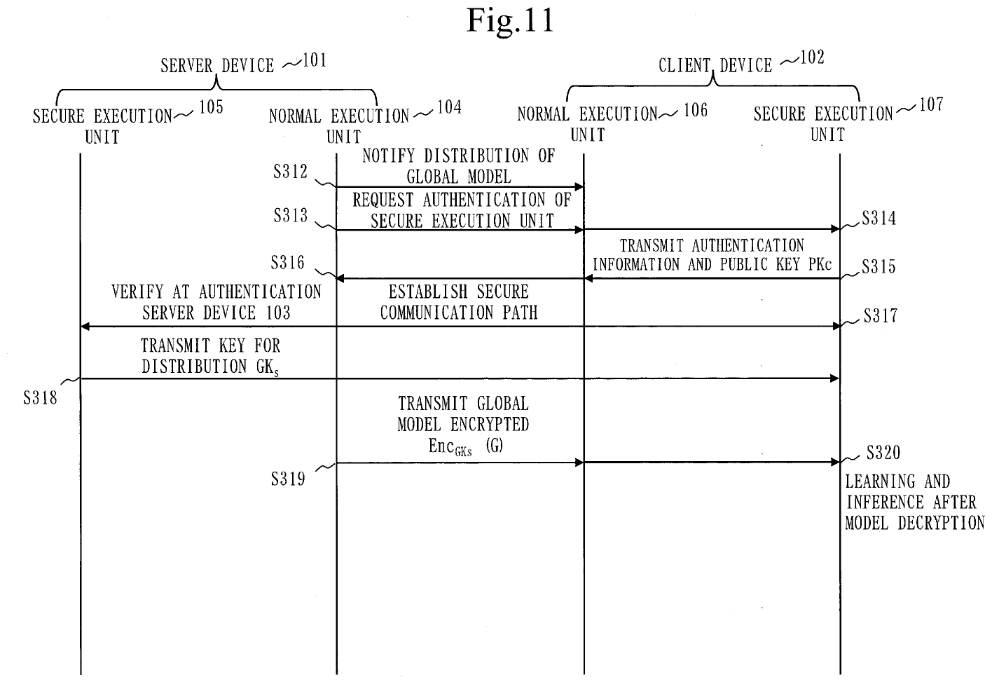

FIG. 11 is a sequence diagram illustrating the operation of distributing the global model in the information processing system 100 according to the present embodiment.

The sequence diagram illustrates communications between the server device 101 and the client device 102 in the information processing system 100 by dividing them by the normal execution units 104 and 106, and the secure execution units 105 and 107.

### <Collecting Client Model>

The process from Step S301 through Step S307 is similar to the process from Step S101 through Step S107 described in First Embodiment. That is, in Step S307, the secure execution unit 107 of the client device 102 transmits a client model M to the secure execution unit 105 of the server device 101 on a secure communication path.

In Step S308, the secure execution unit 105 of the server device 101 once performs homomorphic encryption of the client model M with a temporary key for operation MKs in order to suppress memory consumption of the secure execution unit 105. Then, the secure execution unit 105 of the server device 101 transmits a client model HEMKs (M) homomorphic encrypted to the normal execution unit 104 of the server device 101. The normal execution unit 104 of the server device 101 stores the client model HEMKs (M) homomorphic encrypted.

Step S301 through Step S308 above are performed at each client, and client models are collected from all the client devices 102. After completion of collecting all the client models, next Step S309 is performed.

In Step S309, by using the client model HEMKs (M) homomorphic encrypted, the normal execution unit 104 of the server device 101 executes poisoning detection and aggregation while the client model HEMKs (M) remains encrypted.

In Step S310, by taking the client models aggregated as a global model, the normal execution unit 104 of the server device 101 transmits the global model HEGKs (G) homomorphic encrypted and a poisoning detection result to the secure execution unit 105 of the server device 101.

Lastly, in Step S311, the secure execution unit 105 of the server device 101 decrypts the global model HEGKs (G) homomorphic encrypted and the poisoning detection result. When poisoning is detected, the poisoned client model is not aggregated. For example, when a poisoned client model is detected, the global model may be discarded. The secure execution unit 105 of the server device 101 encrypts the global model G with the temporary key GKs for distribution, and transmits the global model EncGKs (G) encrypted to the normal execution unit 104 of the server device 101. The normal execution unit 104 of the server device 101 stores the global model EncGKs (G) encrypted.

### <Distributing Global Model>

Description will be made on the operation of global model distribution processing by the information processing system 100 using FIG. 11.

The process from Step S312 through Step S320 is similar to the process from Step S112 through Step S120 described in First Embodiment.

That is, lastly, the normal execution unit 106 of the client device 102 transmits the global model EncGKs (G) encrypted to the secure execution unit 107 of the client device 102 in order to perform learning or inference processing in Step S320. The secure execution unit 107 of the client device 102 decrypts, with the temporary key GKs for distribution, the global model EncGKs (G) encrypted, and perform learning or inference processing.

### Description of Effect of Present Embodiment

As described above, in the information processing system 100 according to the present embodiment, the client models and the global model are encrypted, and communicated between the server device 101 and the client devices 102. Further, in the normal execution unit of the server device 101, arithmetic operation is performed while the client models and the global model remain encrypted by homomorphic encryption. Further, the client models and the global model are decrypted only at the secure execution units of each device of the server device 101 and the client devices 102. Therefore, it is possible to secure privacy of the clients and security of the global model.

Further, in the information processing system 100 according to the present embodiment, the validity of each secure execution unit of the server device 101 and the client devices 102 is verified. Therefore, it is possible to prevent invalid processing by an invalid server device 101 and an invalid client device 102.

Furthermore, it is possible to prevent learning obstruction from a malicious client by detecting model poisoning at the time of aggregating the client models.

In addition, aggregation of the client models and model poisoning detection at the server device 101 are realized by performing arithmetic operation at the normal execution units with abundant memory and calculating resources without decrypting encryption using homomorphic encryption since there are limits on the memory resources of the secure execution units.

Further, the global model is encrypted with the temporary key for distribution different from the encryption key for the client model. In this manner, it is possible for the model vendor to own the temporary key for distribution, and to adjust the global model. In this case, since the model vendor does not own the encryption key for the client model, privacy of the client is protected.

### Fourth Embodiment

In the present embodiment, description will be made mainly on different points from First Embodiment, and parts added to First Embodiment.

In the present embodiment, components having functions similar to those in First Embodiment are denoted by the same reference signs, whereof description is omitted.

In First Embodiment, the secure execution unit 105 of the server device 101 includes the poisoning detection unit 114. In the present embodiment, description will be made on a state wherein the secure execution unit 107 of the client device 102 includes the poisoning detection unit 114.

### ***Description of Configuration***

FIG. 12 is a diagram illustrating a configuration example of the information processing system 100 according to the present embodiment.

In the present embodiment, the secure execution unit 105 of the server device 101 described in First Embodiment does not include the poisoning detection unit 114. The secure execution unit 107 of the client device 102 described in First Embodiment includes the poisoning detection unit 114.

The secure execution unit 107 of the client device 102 performs poisoning detection process to detect whether a client model provided to the server device 101 is poisoned. Then, the secure execution unit 107 of the client device 102 behaves so as not to provide the client model poisoned to the server device 101.

The configuration is similar to the configuration of the information processing system 100 described in First Embodiment except for those described above.

In the client device 102, the secure execution unit 107 includes the authentication unit 118, the encryption decrypting unit 119, the poisoning detection unit 114, the learning unit 120 and the inference unit 121.

The poisoning detection unit 114 detects poisoning of the client model provided to the server device 101.

By employing the structure as described above for the information processing system 100 in FIG. 12, the client models and the global model are protected, and validity of each of the secure execution units 105 and 107 and poisoning of a client model are detected. In this manner, federated learning in consideration of security and privacy is realized.

### ***Detailed Description of Function***

Next, the function of each device of the information processing system 100 will be described in more detail using FIG. 12.

A distributed machine learning algorithm represented by federated learning is executed by the communication 123 between the federated learning management units 108 and 115 respectively of the server device 101 and the client device 102. It is assumed that there are a plurality of the client devices 102.

The federated learning management units 108 and 115 verify validity of the secure execution units 105 and 107 with each other by the authentication management units 109 and 116, respectively. The processing is similar to that described in First Embodiment.

The processing by the encryption decrypting unit 111, the processing by the re-encryption decrypting unit 112, and the processing by the aggregation unit 113 in the server device 101 are similar to those in First Embodiment.

The processing by the encryption decrypting unit 119 in the client device 102 is similar to that in First Embodiment.

The poisoning detection unit 114 of the client device 102 performs poisoning detection of the client model provided to the server device 101 (process 435). Poisoning detection is, for example, to calculate an inter-model distance between a client model and a source global model, and when the distance is large, to detect that the client model is poisoned, or to detect that the client model is poisoned from an output result for specific test data.

The processing by the learning and inference management unit 117, the processing by the learning unit 120 and the processing by the inference unit 121 in the client device 102 are similar to those in First Embodiment. However, in the processing by the learning and inference management unit 117, the processing by the learning unit 120 and the processing by the inference unit 121, a client model which is detected to be poisoned is not used.

The example of the hardware configuration of the information processing system 100 according to the present embodiment is similar to that in First Embodiment.

### ***Description of Operation***

As for the operation, the processing of the poisoning detection unit 114 in First Embodiment is performed at the poisoning detection unit 114 in the secure execution unit 107 of the client device 102 before the client model is provided to the server device 101. There are no other changes.

Further, the present embodiment may be applied to Second Embodiment and Third Embodiment. In Second Embodiment and Third Embodiment, the secure execution unit 107 of the client device 102 may include the poisoning detection unit 114. The secure execution unit 107 of the client device 102 performs poisoning detection processing to detect whether the client model provided to the server device 101 is poisoned. Then, the secure execution unit 107 of the client device 102 behaves not to provide the client model poisoned to the server device 101.

In First Embodiment through Fourth Embodiment above, each unit of each device in the information processing system is described as an independent functional block. However, the structure of each device in the information processing system may not be the structure as described in the embodiments above. The functional blocks of each device in the information processing system may have any structure as long as they can realize the functions described in the embodiments above. Further, each device in the information processing system may be one device, or may be a system configured by a plurality of devices.

Furthermore, a plurality of parts of First through Fourth Embodiments may be combined and performed. Otherwise, a part of these embodiments may be performed. In addition, these embodiments may be combined partially or as a whole, and performed in any manner of combination.

That is, in First through Fourth Embodiments, it is possible to freely combine each embodiment, to deform an arbitrary component of each embodiment, or to omit an arbitrary component in each embodiment.

The embodiments as described above are essentially preferable examples, and are not intended for limiting the scope of the present disclosure, the range of application of the present disclosure, and the range of use of the present disclosure. It is possible to variously change the embodiments described above as needed.

### REFERENCE SIGNS LIST

100: information processing system; 101: server device; 102: client device; 103: authentication server device; 104, 106: normal execution unit; 105, 107: secure execution unit; 108, 115: federated learning management unit; 109, 116: authentication management unit; 110, 118: authentication unit; 111, 119: encryption decrypting unit; 112: re-encryption decrypting unit; 113: aggregation unit; 114: poisoning detection unit; 117: learning and inference management unit; 120: learning unit; 121: inference unit; 122: verification unit; 140: homomorphic encryption decrypting unit; 909: electronic circuit; 910: processor; 921: memory unit; 922: auxiliary storage device; 930: input interface; 940: output interface; 950: communication device

1. An information processing system including a server device and a client device, to exchange model information used for learning between the server device and the client device, wherein
each device of the server device and the client device includes processing circuitry being a normal execution environment and processing circuitry being a secure execution environment, as execution environments virtually separated,
the processing circuitry being the normal execution environment in the each device of the server device and the client device authenticates validity of activating the processing circuitry being the secure execution environment in the each device with each other, and when the validity of activating the processing circuitry being the secure execution environment in the each device is authenticated, establishes a secure communication path to transmit and receive data encrypted between processing circuitry being the secure execution environment in the each device,
the processing circuitry being the secure execution environment in the server device performs an aggregation process to decrypt and aggregate the model information provided from the client device via the secure communication path, encrypts the model information obtained by the aggregation process, and transmits the model information encrypted to the processing circuitry being the normal execution environment in the server device,
the processing circuitry being the normal execution environment in the server device stores the model information obtained by the aggregation process in an encrypted state, in a storage, the model information includes a client model provided from the client device to the server device, and a global model distributed from the server device to the client device,
the processing circuitry being the secure execution environment in the server device decrypts the client model provided from the client device via the secure communication path, re-encrypts the client model decrypted, and transmits the client model re-encrypted to the processing circuitry being the normal execution environment in the server device, and
the processing circuitry being the normal execution environment in the server device stores the client model re-encrypted in the storage.

2. The information processing system as defined in claim 1, wherein the processing circuitry being the normal execution environment in the server device transmits the client model re-encrypted to the processing circuitry being the secure execution environment in the server device,
the processing circuitry being the secure execution environment in the server device generates the global model by performing the aggregation process on the client model transmitted from the processing circuitry being the normal execution environment in the server device, encrypts the global model, and transmits the global model encrypted to the processing circuitry being the normal execution environment in the server device, and
the processing circuitry being the normal execution environment in the server device stores the global model encrypted in the storage.

3. The information processing system as defined in claim 1, wherein the processing circuitry being the normal execution environment in the server device divides the client model re-encrypted, and transmits the client model divided to the processing circuitry being the secure execution environment in the server device, and
the processing circuitry being the secure execution environment in the server device performs the aggregation process for each piece of the client model divided.

4. The information processing system as defined in claim 1, wherein the processing circuitry being the secure execution environment in the server device performs a poisoning detection process to detect whether the client model decrypted is poisoned, and does not aggregate a client model poisoned.

5. The information processing system as defined in claim 1, wherein the processing circuitry being the secure execution environment in the client device performs a poisoning detection process to detect whether the client model to be provided to the server device is poisoned, and does not provide a client model poisoned to the server device.

6. An information processing system including a server device and a client device, to exchange model information used for learning between the server device and the client device, wherein
the client device includes a processing circuitry being a normal execution environment being a normal execution environment and a processing circuitry being a secure execution environment being a secure execution environment, as execution environments virtually separated,
the server device includes only a processing circuitry being a normal execution environment being a normal execution environment,
the processing circuitry being the secure execution environment in the client device performs homomorphic encryption of the model information to be provided to the secure device, and
the processing circuitry being the normal execution environment in the server device performs an aggregation process to aggregate the model information homomorphic encrypted while the model information remains homomorphic encrypted, stores the model information obtained by the aggregation process in a homomorphic encrypted state, in a storage, and, performs a poisoning detection process to generate a poisoning detection result to detect poisoning of the model information homomorphic encrypted on a side of the client device while the model information remains homomorphic encrypted.

7. The information processing system as defined in claim 6, wherein the processing circuitry being the normal execution environment in the server device transmits the model information homomorphic encrypted and the poisoning detection result to the client device, and
the processing circuitry being the secure execution environment in the client device performs a poisoning detection process to detect whether the model information to be provided to the server device is poisoned for the poisoning detection result, and transmits model information homomorphic encrypted that is poisoned to the processing circuitry being the normal execution environment in the client device.

8. An information processing system including a server device and a client device, to exchange model information used for learning between the server device and the client device, wherein
each device of the server device and the client device includes a processing circuitry being a normal execution environment being a normal execution environment and processing circuitry being the secure execution environment being a secure execution environment, as execution environments virtually separated,
the processing circuitry being the normal execution environment in the each device of the server device and the client device authenticates validity of activating the processing circuitry being the secure execution environment in the each device with each other, and when the validity of activating the processing circuitry being the secure execution environment in the each device is authenticated, establishes a secure communication path to transmit and receive data encrypted between processing circuitry being the secure execution environment in the each device,
the processing circuitry being the secure execution environment in the server device performs homomorphic encryption of the model information provided from the client device via the secure communication path, and stores the model information homomorphic encrypted while the model information remains homomorphic encrypted, in a storage, and
the processing circuitry being the normal execution environment in the server device performs an aggregation process to aggregate the model information homomorphic encrypted while the model information remains homomorphic encrypted, and stores the model information obtained by the aggregation process in a homomorphic encrypted state, in a storage.

9. The information processing system as defined in claim 8, wherein the processing circuitry being the normal execution environment in the server device performs a poisoning detection process to detect poisoning of the model information homomorphic encrypted while the model information remains homomorphic encrypted.

10. The information processing system as defined in claim 8, wherein the processing circuitry being the secure execution environment in the client device performs a poisoning detection process to detect whether model information to be provided to the server device is poisoned, and does not provide model information poisoned to the server device.

11. An information processing method used for an information processing system including a server device and a client device, to exchange model information used for learning between the server device and the client device, wherein
each device of the server device and the client device includes a normal execution environment and a secure execution environment, as execution environments virtually separated,
the information processing method comprising:
in the normal execution environment in the each device of the server device and the client device, authenticating validity of activating the secure execution environment in the each device with each other, and when the validity of activating the secure execution environment in the each device is authenticated, establishing a secure communication path to transmit and receive data encrypted between secure execution environments in the each device,
in the secure execution environment in the server device, performing an aggregation process to decrypt and aggregate the model information provided via the secure communication path from the client device, encrypting the model information obtained by the aggregation process, and transmitting the model information encrypted to the normal execution environment in the server device, and
in the normal execution environment in the server device, storing the model information obtained by the aggregation process in an encrypted state, in a memory,
and wherein the model information includes a client model provided from the client device to the server device, and a global model distributed from the server device to the client device,
the information processing method further comprising:
in the secure execution environment in the server device, decrypting the client model provided from the client device via the secure communication path, re-encrypting the client model decrypted, and transmitting the client model re-encrypted to the server device, and
in the secure execution environment in the server device, storing the client model re-encrypted in a memory.

12. An information processing method used for an information processing system including a server device and a client device, to exchange model information used for learning between the server device and the client device, wherein
the client device includes a normal execution environment and a secure execution environment, as execution environments virtually separated, and
the server device includes only a normal execution environment,
the information processing method comprising:
in the secure execution environment in the client device, performing homomorphic encryption of the model information to be provided to the server device, and
in the normal execution environment in the server device, performing an aggregation process to aggregate the model information homomorphic encrypted while the model information remains homomorphic encrypted, storing the model information obtained by the aggregation process in a homomorphic encrypted state, in a memory, and performing a poisoning detection process to generate a poisoning detection result to detect poisoning of the model information homomorphic encrypted on a side of the client device while the model information remains homomorphic encrypted.

13. An information processing method used for an information processing system including a server device and a client device, to exchange model information used for learning between the server device and the client device, wherein
each device of the server device and the client device includes a normal execution environment and a secure execution environment, as execution environments virtually separated,
the information processing method comprising:
in the normal execution environment in the each device of the server device and the client device, authenticating validity of activating the secure execution environment in the each device with each other, and when the validity of activating the secure execution environment in the each device is authenticated, establishing a secure communication path to transmit and receive data encrypted between secure execution environments in the each device,
in the secure execution environment in the server device, performing homomorphic encryption of the model information provided from the client device via the secure communication path, and storing the model information homomorphic encrypted in a homomorphic encrypted state, in a memory, and
in the normal execution environment in the server device, performing an aggregation process to aggregate the model information homomorphic encrypted while the model information remains homomorphic encrypted, and storing the model information obtained by the aggregation process in a homomorphic encrypted state, in a memory.

14. A non-transitory computer readable medium storing an information processing program used for an information processing system including a server device and a client device, to exchange model information used for learning between the server device and the client device, wherein
each device of the server device and the client device includes a normal execution environment and a secure execution environment, as execution environments virtually separated,
the information processing program to cause a computer to perform:
in the normal execution environment in the each device of the server device and the client device, a process to authenticate validity of activating the secure execution environment in the each device with each other, and when the validity of activating the secure execution environment in the each device is authenticated, to establish a secure communication path to transmit and receive data encrypted between secure execution environments in the each device,
in the secure execution environment in the server device, a process to perform an aggregation process to decrypt and aggregate the model information provided from the client device via the secure communication path, to encrypt the model information obtained by the aggregation process, to encrypt the model information obtained by the aggregation process, and to transmit the model information encrypted to the normal execution environment in the server device, and
in the normal execution environment in the server device, a process to store the model information obtained by the aggregation process in an encrypted state, in a memory,
and wherein the model information includes a client model provided from the client device to the server device, and a global model distributed from the server device to the client device,
the information processing program to further cause a computer to perform:
in the secure execution environment in the server device, decrypting the client model provided from the client device via the secure communication path, re-encrypting the client model decrypted, and transmitting the client model re-encrypted to the normal execution environment in the server device, and
in the normal execution environment in the server device, storing the client model re-encrypted in a memory.

15. A non-transitory computer readable medium storing an information processing program used for an information processing system including a server device and a client device, to exchange model information used for learning between the server device and the client device, wherein
the client device includes a normal execution environment and a secure execution environment, as execution environments virtually separated, and
the server device only includes a normal execution environment,
the information processing program to cause a computer to perform:
in the secure execution environment in the client device, a process to perform homomorphic encryption of the model information to be provided to the server device, and
in the normal execution environment in the server device, a process to perform an aggregation process to aggregate the model information homomorphic encrypted while the model information remains homomorphic encrypted, to store the model information obtained by the aggregation process in a homomorphic encrypted state, in a memory, and to perform a poisoning detection process to generate a poisoning detection result to detect poisoning of the model information homomorphic encrypted on a side of the client device while the model information remains homomorphic encrypted.

16. A non-transitory computer readable medium storing an information processing program used for an information processing system including a server device and a client device, to exchange model information used for learning between the server device and the client device, wherein
each device of the server device and the client device includes a normal execution environment and a secure execution environment, as execution environments virtually separated,
the information processing program to cause a computer to perform:
in the normal execution environment in the each device of the server device and the client device, a process to authenticate validity of activating the secure execution environment in the each device with each other, and when the validity of activating the secure execution environment in the each device is authenticated, to establish a secure communication path to transmit and receive data encrypted between secure execution environments in the each device,
in the secure execution environment in the server device, a process to perform homomorphic encryption of the model information provided from the client device via the secure communication path, and to store the model information homomorphic encrypted in a homomorphic encrypted state, in a memory, and
in the normal execution environment in the server device, a process to perform an aggregation process to aggregate the model information homomorphic encrypted while the model information remains homomorphic encrypted, and to store the model information obtained by the aggregation process in a homomorphic encrypted state, in a memory.
